(19) United States
(12) Patent Application Publication
(10) Pub. No.: US 2022/0148484 A1
(43) Pub. Date: May 12, 2022

(54) DISPLAY HAVING PIXELS

(71) Applicant: Hewlett-Packard Development Company, L.P., Spring, TX (US)

(72) Inventors: Hsing-Hung Hsieh, Taipei City (TW); Kuan-Ting Wu, Taipei City (TW); Chi Hao Chang, Taipei City (TW)

(73) Assignee: Hewlett-Packard Development Company, L.P., Spring, TX (US)

(21) Appl. No.: 17/419,265

(22) PCT Filed: Jul. 29, 2019
(86) PCT No.: PCT/US2019/043874

§ 371 Date: Jun. 28, 2021

(51) Int. Cl. G09G 3/20; G06F 1/16

(52) U.S. Cl. CPC G09G 3/2003; G09G 2300/0452; G09G 2300/02; G06F 1/1616

(57) ABSTRACT

In some examples, a display comprises a first side, where the first side comprises a first portion of pixels that emit light to the first side of the display and a second portion of pixels, where a first subset of the second portion of pixels emit light to the first side of the display, and a second side comprising a second subset of the second portion of pixels that emit light to the second side of the display, where the first portion of pixels has a pixel density and the second portion of pixels has a pixel density.

### BACKGROUND

A display may be utilized to display information. The information displayed may include text, images, and/or video, among other types of information. A display may include a display area having pixels. The pixels of the display area may be controllable such that the pixels can display different colors, which can comprise the displayed information by the display.

### BRIEF DESCRIPTION OF THE DRAWINGS

FIG. 1 illustrates an example of a computing device with a display having pixels consistent with the disclosure.

FIG. 2 illustrates an example of a display having a first portion of pixels and a second portion of pixels consistent with the disclosure.

FIG. 3 illustrates an example of a display having a first portion of pixels and a second portion of pixels consistent with the disclosure.

FIG. 4 illustrates an example of a display having a first portion of pixels and a second portion of pixels consistent with the disclosure.

FIG. 5A illustrates an example of a display having a first portion of pixels and a second portion of RBG pixels consistent with the disclosure.

FIG. 5B illustrates an example of a display having a first portion of pixels and a second portion of RGB pixels consistent with the disclosure.

FIG. 6A illustrates an example of a display having a first subset of a second portion of pixels in a delta arrangement consistent with the disclosure.

FIG. 6B illustrates an example of a display having a second subset of a second portion of pixels in a delta arrangement consistent with the disclosure.

### DETAILED DESCRIPTION

A computing device can include a display. As used herein, the term “computing device” refers to a portable personal computing device. A computing device can be, for example, a laptop computer and/or a notebook, among other types of computing devices. The display of the computing device can display information to a user such as text, images, and/or video, among other types of information. As used herein, the term “display” refers to an output device that includes a display area that displays information provided by an electrical signal in a visual and/or tactile form. As used herein, the term “display area” refers to an area of a display that displays information. For example, a computing device can include a display area that can display information such as text, videos, and/or images via pixels included in the display area of the display as a result of an electrical signal provided to the display from the computing device.

Some computing devices may include a display in which the pixels comprising the display area of the display are to emit light on one side of the display. As used herein, the term “pixel” refers to a smallest controllable element of a display area of a display. In such an example computing device, information can be presented to the user from one side of the display.

In some computing devices, the display area of the display may include an area in which some of the pixels can emit light to one side of the display, and some of the pixels can emit light to a different side of the display. For example, information can be presented to a user on a laptop computer via a first side of the display (e.g., a front side of the display), and a portion of the pixels comprising the display can allow for information to be presented to the user and/or a different user via a second side of the display (e.g., a back side of the display).

However, the resolution of the portion of the display that has pixels emitting light to the first side of the display and other pixels emitting light to the second side of the display may be lower than the resolution of the remaining portion of the display having pixels emitting light to the first side of the display. As used herein, the term “resolution” refers to an amount of pixels per unit area on a display screen. Since there may be less pixels emitting light to the first side of the display in the portion having pixels emitting light to the second side of the display relative to the portion of the display with all of the pixels emitting light to the first side of the display, a user may perceive a visual artifact as a result.

A display having pixels according to the disclosure can allow for a first side of a display having a first portion of pixels that emit light to the first side of the display and a second portion of pixels that emit light to the first side of the display and the second side of the display to achieve presentation of information to two sides of the display with a single display without a visual artifact being present in the first side of the display. A single display can present information to two sides of the display while reducing a thickness of the display, cost of the display, and/or power consumption of the display as compared to utilizing two separate displays.

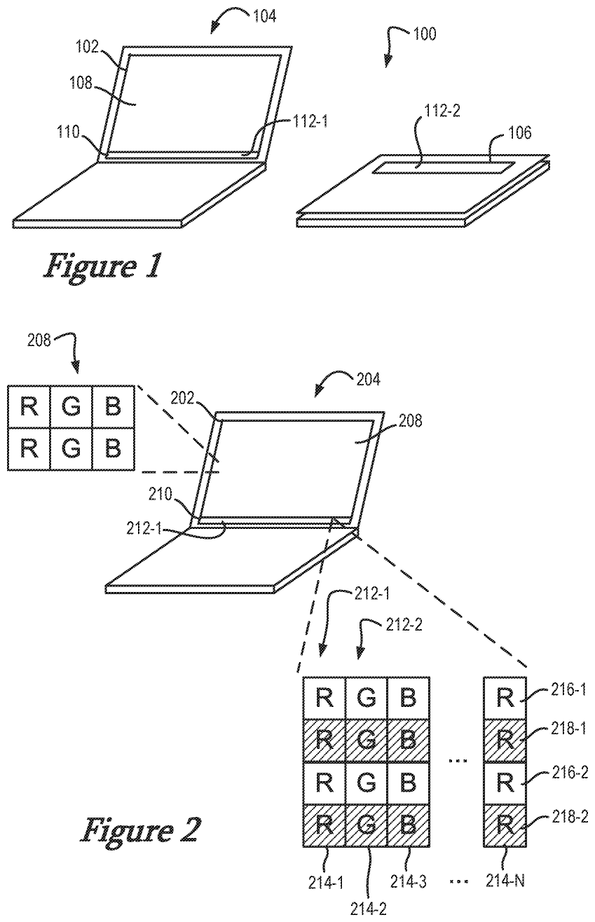

FIG. 1 illustrates an example of a computing device 100 with a display having pixels consistent with the disclosure. The computing device 100 can include a display 102, a first side 104 of the display 102, and a second side 106 of the display 102.

As illustrated in FIG. 1, the computing device 100 can include a display 102. The display 102 can include a first side 104 and a second side 106. The first side 104 of the display 102 of the computing device 100 can display information to a user in the open position (e.g., as illustrated in the orientation of the computing device 100 on the left in FIG. 1). A user may utilize computing device 100 by inputting information to the computing device 100 and/or viewing information displayed on the first side 104 of the display 102 in the open position of the computing device 100.

The second side 106 of the display 102 of the computing device 100 can display information to the user in the closed position (e.g., as illustrated in the orientation of the computing device 100 on the right in FIG. 1). A user may view information displayed on the second side 106 of the display 102 in the closed position of the computing device 100. For example, the second side 106 of the display 102 may display messages, text, email (e.g., subject lines, the email content, etc.), among other information while the computing device 100 is in the closed position.

The first side 104 of the display 102 can include a first portion of pixels 108 and a second portion of pixels 110. The first portion of pixels 108 can emit light to the first side 104 of the display. As used herein, the term “emit light” refers to sending forth of light. For example, the first portion of pixels 108 can emit light towards a user of the computing device 100 while the computing device 100 is in the open position in order to display information to the user such as text, images, and/or video.

The first side 104 of the display 102 can include a second portion of pixels 110. The second portion of pixels 110 can include a first subset 112-1 of the second portion of pixels 110 and a second subset 112-2 of the second portion of pixels 110. The first subset 112-1 of the second portion of pixels 110 can emit light towards a user of the computing device 100 while the computing device 100 is in the open position in order to display information to the user such as text, images, and/or video. The second subset 112-2 of the second portion of pixels 110 can emit light towards a user of the computing device 100 while the computing device 100 is in the closed position in order to display information to the user such as text, images, and/or video.

The first portion of pixels 108 and the second portion of pixels 110 can be red, green, and blue (RGB) pixels. For example, each pixel of the first portion of pixels 108 and the second portion of pixels 110 can be a red, green, and blue (RGB) sub-pixel.

The first portion of pixels 108 and the first subset 112-1 of the second portion of pixels 110 of the first side 104 of the display 102 can be utilized together to display complete information to a user in the open position of the computing device 100. For example, the first portion of pixels 108 and the first subset 112-1 of the second portion of pixels 110 of the first side 104 of the display 102 can be utilized together to display complete text, images, and/or video to a user in the open position of the computing device 100.

Additionally, the second subset 112-2 of the second portion of pixels 110 of the second side 106 of the display 102 can display complete information to a user in the closed position of the computing device 100. For example, the second subset 112-2 of the second portion of pixels 110 of the display 102 can be utilized together to display complete text, images, and/or video to a user in the closed position of the computing device 100. By using different pixel arrangements in the first subset 112-1 and the second subset 112-2 of the second portion of pixels, the display 102 can present information to two sides 104, 106 of the display 102 without a visual artifact being present in the first side 104 of the display 102, as is further described herein.

FIG. 2 illustrates an example of a display 202 having a first portion of pixels 208 and a second portion of pixels 210 consistent with the disclosure. The second portion of pixels 210 can include a first subset 212-1 of pixels and a second subset 212-2 of pixels.

As illustrated in FIG. 2, the first side 204 of the display 202 can include a first portion of pixels 208 and a second portion of pixels 210. The first portion of pixels 208 can emit light to the first side 204 of the display 202. The second portion of pixels 210 can include a first subset 212-1 of the second portion of pixels 210 and a second subset 212-2 of the second portion of pixels 210. The first subset 212-1 of the second portion of pixels 210 can emit light to the first side 204 of the display 202 and the second subset 212-2 of the second portion of pixels 210 can emit light to a second side (e.g., second side 106, previously described in connection with FIG. 1) of the display 202.

As illustrated in the zoomed in portion of the first portion 208 of pixels, the first portion 208 of pixels can include columns and rows. The columns can be subpixels having a color component. As used herein, the term “color component” refers to a constituent part of a pixel. For example, a color component of a pixel can be a constituent part of an RGB pixel. For instance, the left column of the zoomed in portion of the first portion 208 of pixels can be a red color component (e.g., illustrated in FIG. 2 as “R”), the middle column of the zoomed in portion of the first portion 208 of pixels can be a green color component (e.g., illustrated in FIG. 2 as “G”), and the right column of the zoomed in portion of the first portion 208 of pixels can be a blue color component (e.g., illustrated in FIG. 2 as “B”). Although the first portion is illustrated in FIG. 2 as including three columns and two rows, examples of the disclosure are not so limited. For example, the second portion first portion can include more than three columns and/or more than two rows.

Although the first portion 208 of pixels is illustrated in FIG. 2 as including columns in an “RGB” order (e.g., left to right as illustrated in FIG. 2), examples of the disclosure are not so limited. For example, the first portion 208 of pixels can include columns in an “RBG” order (e.g., left to right as illustrated in FIG. 2), or any other order of color components of RGB pixels.

The first portion 208 of pixels can include a pixel density. As used herein, the term “pixel density” refers to an amount of pixels in an area of a display. For example, the pixel density of the first portion 208 of pixels can be 300 pixels per inch (ppi). However, examples of the disclosure are not so limited. For example, the pixel density of the first portion 208 of pixels can be more than 300 ppi or less than 300 ppi.

The second portion 210 of pixels can include columns 214-1, 214-2, 214-3, 214-N, and rows 216-1, 216-2 and 218-1, 218-2. Similar to the first portion of pixels 208, the columns can be subpixels having a color component. For example, column 214-1 can be a red color component (e.g., “R”), column 214-2 can be a green color component (e.g., “G”), and column 214-3 can be a blue color component (e.g., “B”), as is further described herein. Further, although the second portion 210 of pixels are illustrated as including three columns and four rows, examples of the disclosure are not so limited. For example, the second portion 210 of pixels can include more than three columns and/or more than four rows.

The pixel density of the second portion 210 of pixels can be higher than the pixel density of the first portion 208 of pixels. For example, the pixel density of the second portion 210 of pixels can be double the pixel density of the first portion 208 of pixels. For instance, the pixel density of the first portion 208 of pixels can be 300 ppi, while the pixel density of the second portion 210 of pixels can be 600 ppi. However, examples of the disclosure are not so limited. For instance, the pixel density of the first portion 208 of pixels can be 150 ppi, while the pixel density of the second portion 210 of pixels can be 300 ppi, among other examples.

As illustrated in FIG. 2, rows 216-1 and 216-2 can include RGB pixels that emit light to the first side 204 of the display 202 (e.g., indicated in FIG. 2 by an empty rectangle without cross-hatching). Rows 218-1 and 218-2 can include RGB pixels that emit light to the second side (e.g., second side 106) of the display 202 (e.g., indicated in FIG. 2 by a rectangle with cross-hatching).

The first column 214-1 can include subpixels having a first color component. As illustrated in FIG. 2, the first color component in column 214-1 can be red (e.g., “R”). Adjacent subpixels of the first color component can altemately emit light to the first side 204 of the display 202 and to the second side of the display 202. For example, a red subpixel in column 214-1 and row 216-1 can emit light to the first side 204 of the display 202, a red subpixel in column 214-1 and row 216-2 can emit light to the second side of the display 202, a red subpixel in column 214-1 and row 216-3 can emit light to the first side 204 of the display 202, a red subpixel in column 214-1 and row 216-4 can emit light to the second side of the display 202, etc.

The second column 214-2 can include subpixels having a second color component. As illustrated in FIG. 2, the second color component in column 214-2 can be green (e.g., “G”). Adjacent subpixels of the second color component can alternately emit light to the first side 204 of the display 202 and to the second side of the display 202. For example, a green subpixel in column 214-2 and row 216-1 can emit light to the first side 204 of the display 202, a green subpixel in column 214-2 and row 216-2 can emit light to the second side of the display 202, a green subpixel in column 214-2 and row 216-3 can emit light to the first side 204 of the display 202, a green subpixel in column 214-2 and row 216-4 can emit light to the second side of the display 202, etc.

The third column 214-3 can include subpixels having a third color component. As illustrated in FIG. 2, the third color component in column 214-3 can be blue (e.g., “B”). Adjacent subpixels of the third color component can alternately emit light to the first side 204 of the display 202 and to the second side of the display 202. For example, a blue subpixel in column 214-3 and row 216-1 can emit light to the first side 204 of the display 202, a blue subpixel in column 214-3 and row 216-2 can emit light to the second side of the display 202, a blue subpixel in column 214-3 and row 216-3 can emit light to the first side 204 of the display 202, a blue subpixel in column 214-3 and row 216-4 can emit light to the second side of the display 202, etc.

In other words, the second portion 210 of pixels can include an arrangement whereby different rows of pixels can alternately emit light to the first side 204 and second side of the display 202. Altemately emitting light to the first side 204 and the second side of the display 202 can prevent a visual artifact from being viewable by a user viewing the combined first portion 208 of pixels and second portion 210 of pixels when viewing the display 202 from the first side 204, while also allowing the second side (e.g., second side 106) of the display 202 to display information to a user.

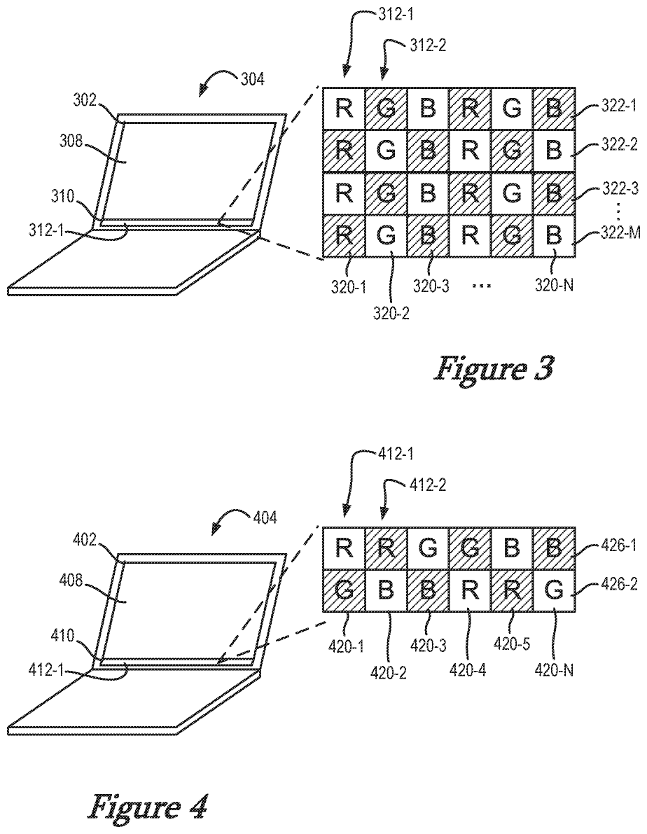

FIG. 3 illustrates an example of a display having a first portion 308 of pixels and a second portion 310 of pixels consistent with the disclosure. The second portion 310 of pixels can include a first subset 312-1 of pixels and a second subset 312-2 of pixels.

Although not illustrated in FIG. 3, the display 302 can include a first portion of pixels. The first portion of pixels can be similar to the first portion of pixels 208, previously described in connection with FIG. 2. The first portion of pixels can emit light to the first side 304 of the display.

The display 302 can include a second portion of pixels 310. The second portion of pixels 310 can include a first subset 312-1 of the second portion of pixels 310 and a second subset 312-2 of the second portion of pixels 310. The first subset 312-1 of the second portion of pixels 310 can emit light to the first side 304 of the display 302 (e.g., indicated in FIG. 3 by an empty rectangle without cross-hatching) and the second subset 312-2 of the second portion of pixels 310 can emit light to a second side (e.g., second side 106, previously described in connection with FIG. 1) of the display 302 (e.g., indicated in FIG. 3 by a rectangle with cross-hatching).

The second portion 310 of pixels can include columns 320-1, 320-2, 320-3, 320-N, and rows 322-1, 322-2, 322-3, 322-M. The columns 320 can be subpixels having a color component. For example, column 320-1 can be a red color component (e.g., “R”), column 320-2 can be a green color component (e.g., “G”), and column 320-3 can be a blue color component (e.g., “B”), as is further described herein. Further, although six columns and four rows are illustrated in FIG. 3, examples of the disclosure are not so limited. For example, the second portion 310 of pixels can include more than six columns and/or more than four rows.

Similar to the example described in FIG. 2, the pixel density of the second portion 310 of pixels can be higher than the pixel density of the first portion 308 of pixels. For example, the pixel density of the second portion 310 of pixels can be double the pixel density of the first portion 308 of pixels. For instance, the pixel density of the first portion 308 of pixels can be 300 ppi, while the pixel density of the second portion 310 of pixels can be 600 ppi. However, examples of the disclosure are not so limited. For instance, the pixel density of the first portion 308 of pixels can be 150 ppi, while the pixel density of the second portion 310 of pixels can be 300 ppi, among other examples.

Each row 322 can include a first subpixel having a first color component, a second subpixel having a second color component, and a third subpixel having a third color component. The first, second, and third subpixels of each row 322 can alternately emit light to the first side 304 of the display 302 and to the second side of the display 302, as is further described herein.

For example, a red subpixel included in column 320-1 and row 322-1 can emit light to the first side 304 of the display 302, a green subpixel included in column 320-2 and row 322-1 can emit light to the second side of the display 302, a blue subpixel included in column 320-3 and row 322-1 can emit light to the first side 304 of the display 302, etc. Additionally, a red subpixel included in column 320-1 and row 322-2 can emit light to the second side of the display 302, a green subpixel included in column 320-2 and row 322-2 can emit light to the first side 304 of the display 302, a blue subpixel included in column 320-3 and row 322-2 can emit light to the second side of the display 302, etc. Further, a red subpixel included in column 320-1 and row 322-3 can emit light to the first side 304 of the display 302, a green subpixel included in column 320-2 and row 322-3 can emit light to the second side of the display 302, a blue subpixel included in column 320-3 and row 322-3 can emit light to the first side 304 of the display 302, etc.

In other words, the second portion 310 of pixels can include a zig-zag pixel arrangement (e.g., a delta pixel arrangement) whereby different pixels in a particular row and/or column can alternately emit light to the first side 304 and second side of the display 302. Altemately emitting light to the first side 304 and the second side of the display 302 can prevent a visual artifact from being viewable by a user viewing the combined first portion 308 of pixels and second portion 310 of pixels when viewing the display 302 from the first side 304, while also allowing the second side (e.g., second side 106) of the display 302 to display information to a user.

FIG. 4 illustrates an example of a display having a first portion 408 of pixels and a second portion 410 of pixels consistent with the disclosure. The second portion 410 of pixels can include a first subset 412-1 of pixels and a second subset 412-2 of pixels.

Although not illustrated in FIG. 4, the display 402 can include a first side 404 having a first portion of pixels 408 that emit light to the first side 404 of the display and a second portion of pixels 410. The first portion of pixels can be similar to the first portion of pixels 208, previously described in connection with FIG. 2.

The display 402 can include a second portion of pixels 410. The second portion of pixels 410 can include a first subset 412-1 of the second portion of pixels 410 and a second subset 412-2 of the second portion of pixels 410. The first subset 412-1 of the second portion of pixels 410 can emit light to the first side 404 of the display 402 (e.g., indicated in FIG. 4 by an empty rectangle without cross-hatching) and the second subset 412-2 of the second portion of pixels 410 can emit light to a second side (e.g., second side 106, previously described in connection with FIG. 1) of the display 402 (e.g., indicated in FIG. 4 by a rectangle with cross-hatching).

The second portion 410 of pixels can include columns 424-1, 424-2, 424-3, 424-4, 424-5, 424-N and rows 426-1, 426-2. The columns 424 can be subpixels having different color components. Although six columns and two rows are illustrated in FIG. 4, examples of the disclosure are not so limited. For example, the second portion 410 of pixels can include more than six columns and/or more than two rows.

The pixel density of the second portion 410 of pixels can be the same pixel density as the pixel density of the first portion 408 of pixels. For example, the pixel density of the first portion 408 of pixels can be 300 ppi, while the pixel density of the second portion 410 of pixels can also be 300 ppi. However, examples of the disclosure are not so limited. For instance, the pixel density of the first portion 408 of pixels can be 150 ppi, while the pixel density of the second portion 410 of pixels can also be 150 ppi, among other examples.

Each row 426 of the second portion 410 of pixels can include adjacent subpixel pairs having same color components. For example, as illustrated in FIG. 4, row 426-1, columns 424-1, 424-2 can include adjacent subpixel pairs having a red color component (e.g., “R”), row 426-1, columns 424-3, 424-4 can include adjacent subpixel pairs having a green color component (e.g., “G”), and row 426-1, columns 424-5, 424-N can include adjacent subpixel pairs having a blue color component (e.g., “B”). Additionally, row 426-2, columns 424-2, 424-3 can include adjacent subpixel pairs having a blue color component (e.g., “B”), row 426-2, columns 424-4, 424-5 can include adjacent subpixel pairs having a red color component (e.g., “R”), etc. Adjacent subpixels of the subpixel pairs can altemately emit light to the first side 404 and the second side of the display 402, as is further described herein.

For example, a first subpixel pair can include a first subpixel (e.g., row 426-1, column 424-1) having the red color component to emit light to the first side 404 of the display 402 and a second subpixel (e.g., row 426-1, column 424-2) having the red color component to emit light to the second side of the display 402. Additionally, a second subpixel pair can include a first subpixel (e.g., row 426-1, column 424-3) having the green color component to emit light to the first side 404 of the display 402 and a second subpixel (e.g., row 426-1, column 424-4) having the green color component to emit light to the second side of the display 402. Further, a third subpixel pair can include a first subpixel (e.g., row 426-1, column 424-5) having the blue color component to emit light to the first side 404 of the display 402 and a second subpixel (e.g., row 426-1, column 424-N) having the blue color component to emit light to the second side of the display 402.

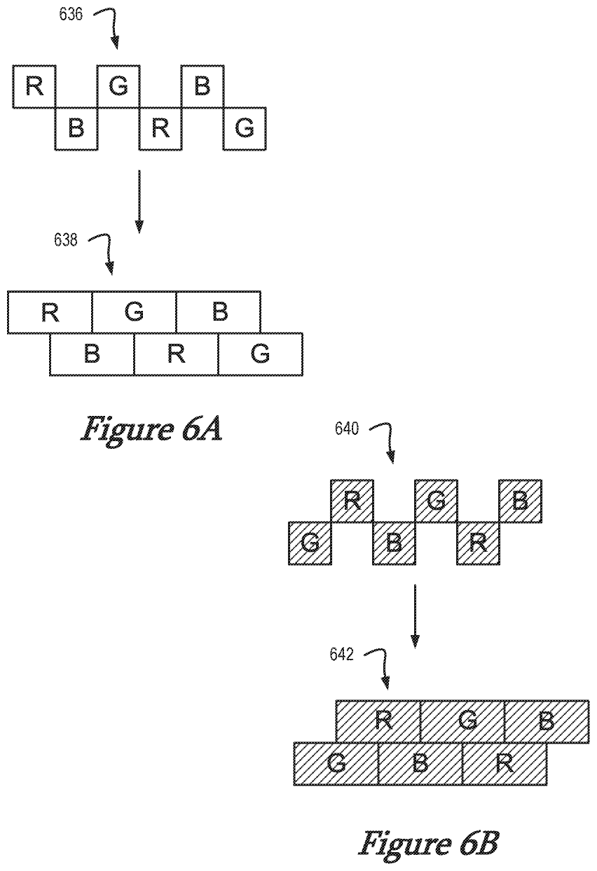

In other words, the second portion 410 of pixels can be arranged in what appears to a user when viewed by the user to be a delta pixel arrangement (e.g., as is further described in connection with FIGS. 6A and 6B), whereby different subpixels comprising a pixel pair of the same color component can alternately emit light to the first side 404 and second side of the display 402. Alternately emitting light to the first side 404 and the second side of the display 402 can prevent a visual artifact from being viewable by a user viewing the combined first portion 408 of pixels and second portion 410 of pixels when viewing the display 402 from the first side 404, while also allowing the second side (e.g., second side 106) of the display 402 to display information to a user. Further, utilizing the same pixel density in the second portion 410 of pixels as the first portion 408 of pixels can allow for easy manufacturing, more efficient power consumption, etc.

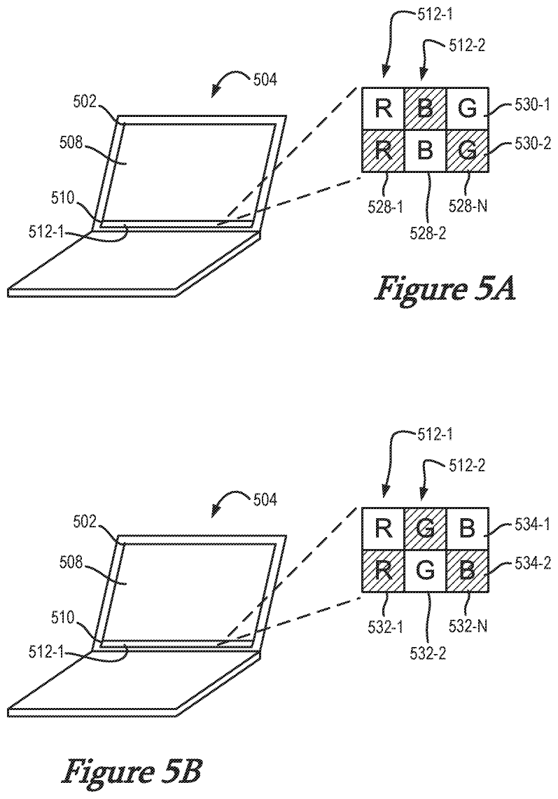

FIG. 5A illustrates an example of a display having a first portion 508 of pixels and a second portion 510 of RBG pixels consistent with the disclosure. The second portion 510 of pixels can include a first subset 512-1 of pixels and a second subset 512-2 of pixels.

Although not illustrated in FIG. 5A, the display 502 can include a first side 504 having a first portion of pixels 508 that emit light to the first side 504 of the display and a second portion of pixels 510. The first portion of pixels 508 can be similar to the first portion of pixels 208, previously described in connection with FIG. 2.

The display 502 can include a second portion of pixels 510. The second portion of pixels 510 can include a first subset 512-1 of the second portion of pixels 510 and a second subset 512-2 of the second portion of pixels 510. The first subset 512-1 of the second portion of pixels 510 can emit light to the first side 504 of the display 502 (e.g., indicated in FIG. 5A by an empty rectangle without cross-hatching) and the second subset 512-2 of the second portion of pixels 510 can emit light to a second side (e.g., second side 106, previously described in connection with FIG. 1) of the display 502 (e.g., indicated in FIG. 5A by a rectangle with cross-hatching).

The second portion 510 of pixels can include columns 528-1, 528-2, 528-N, and rows 530-1, 530-2. The columns 528 can be subpixels having a color component. For example, column 528-1 can be a red color component (e.g., “R”), column 528-2 can be a blue color component (e.g., “B”), and column 528-N can be a green color component (e.g., “G”), as is further described herein. Further, although three columns and two rows are illustrated in FIG. 5A, examples of the disclosure are not so limited. For example, the second portion 510 of pixels can include more than three columns and/or more than two rows.

The pixel density of the second portion 510 of pixels can be the same pixel density as the pixel density of the first portion 508 of pixels. For example, the pixel density of the first portion 508 of pixels can be 300 ppi, while the pixel density of the second portion 510 of pixels can also be 300 ppi. However, examples of the disclosure are not so limited. For instance, the pixel density of the first portion 508 of pixels can be 150 ppi, while the pixel density of the second portion 510 of pixels can also be 150 ppi, among other examples.

Each row 530 can include a first subpixel having a first color component, a second subpixel having a second color component, and a third subpixel having a third color component. The first, second, and third subpixels of each row 530 can alternately emit light to the first side 504 of the display 502 and to the second side of the display 502. In other words, adjacent subpixels of each color component (e.g., RBG) can alternately emit light to the first side 504 of the display 502 and to the second side of the display 502, as is further described herein.

The first column 528-1 can include subpixels having a first color component. As illustrated in FIG. 5A, the first color component in column 528-1 can be red (e.g., “R”). Adjacent subpixels of the first color component can alternately emit light to the first side 504 of the display and to the second side of the display 502. For example, a red subpixel in column 528-1 and row 530-1 can emit light to the first side 504 of the display, a red subpixel in column 528-1 and row 530-2 can emit light to the second side of the display 502, etc.

The second column 528-2 can include subpixels having a second color component. As illustrated in FIG. 5A, the second color component in column 528-2 can be blue (e.g., “B”). Adjacent subpixels of the second color component can alternately emit light to the second side of the display and to the first side 504 of the display 502. For example, a blue subpixel in column 528-2 and row 530-1 can emit light to the second side of the display 502, a blue subpixel in column 528-2 and row 530-2 can emit light to the first side 504 of the display 502, etc.

The third column 528-3 can include subpixels having a third color component. As illustrated in FIG. 5A, the third color component in column 528-N can be green (e.g., “G”). Adjacent subpixels of the third color component can alternately emit light to the first side 504 of the display and to the second side of the display 502. For example, a green subpixel in column 528-N and row 530-1 can emit light to the first side 504 of the display, a green subpixel in column 528-N and row 530-2 can emit light to the second side of the display 502, etc.

In other words, the second portion 510 of pixels can include an arrangement whereby different rows of pixels can alternately emit light to the first side 504 and second side of the display 502. The second portion 510 of pixels can be arranged in what appears to a user when viewed by the user to be a delta pixel arrangement (e.g., as is further described in connection with FIGS. 6A and 6B). Alternately emitting light to the first side 504 and the second side of the display 502 can prevent a visual artifact from being viewable by a user viewing the combined first portion 508 of pixels and second portion 510 of pixels when viewing the display 502 from the first side 504, while also allowing the second side (e.g., second side 106) of the display 502 to display information to a user. Further, utilizing the same pixel density in the second portion 510 of pixels as the first portion 508 of pixels can allow for easy manufacturing, more efficient power consumption, etc.

FIG. 5B illustrates an example of a display having a first portion 508 of pixels and a second portion 510 of RGB pixels consistent with the disclosure. The second portion 510 of pixels can include a first subset 512-1 of pixels and a second subset 512-2 of pixels.

Although not illustrated in FIG. 5B, the display 502 can include a first side 504 having a first portion of pixels 508 that emit light to the first side 504 of the display and a second portion of pixels 510. The first portion of pixels 508 can be similar to the first portion of pixels 208, previously described in connection with FIG. 2.

The display 502 can include a second portion of pixels 510. The second portion of pixels 510 can include a first subset 512-1 of the second portion of pixels 510 and a second subset 512-2 of the second portion of pixels 510. The first subset 512-1 of the second portion of pixels 510 can emit light to the first side 504 of the display 502 (e.g., indicated in FIG. 5B by an empty rectangle without cross-hatching) and the second subset 512-2 of the second portion of pixels 510 can emit light to a second side (e.g., second side 106, previously described in connection with FIG. 1) of the display 502 (e.g., indicated in FIG. 5B by a rectangle with cross-hatching).

The second portion 510 of pixels can include columns 532-1, 532-2, 532-N, and rows 534-1, 534-2. The columns 532 can be subpixels having a color component. For example, column 532-1 can be a red color component (e.g., “R”), column 532-2 can be a green color component (e.g., “G”), and column 532-N can be a red color component (e.g., “R”), as is further described herein. Further, although three columns and two rows are illustrated in FIG. 5B, examples of the disclosure are not so limited. For example, the second portion 510 of pixels can include more than three columns and/or more than two rows.

The pixel density of the second portion 510 of pixels can be the same pixel density as the pixel density of the first portion 508 of pixels. For example, the pixel density of the first portion 508 of pixels can be 300 ppi, while the pixel density of the second portion 510 of pixels can also be 300 ppi. However, examples of the disclosure are not so limited. For instance, the pixel density of the first portion 508 of pixels can be 150 ppi, while the pixel density of the second portion 510 of pixels can also be 150 ppi, among other examples.

Each row 534 can include a first subpixel having a first color component, a second subpixel having a second color component, and a third subpixel having a third color component. The first, second, and third subpixels of each row 534 can altemately emit light to the first side 504 of the display 502 and to the second side of the display 502. In other words, adjacent subpixels of each color component (e.g., RGB) can altemately emit light to the first side 504 of the display 502 and to the second side of the display 502, as is further described herein.

The first column 528-1 can include subpixels having a first color component. As illustrated in FIG. 5B, the first color component in column 532-1 can be red (e.g., “R”). Adjacent subpixels of the first color component can altemately emit light to the first side 504 of the display and to the second side of the display 502. For example, a red subpixel in column 532-1 and row 534-1 can emit light to the first side 504 of the display, a red subpixel in column 532-1 and row 534-2 can emit light to the second side of the display 502, etc.

The second column 532-2 can include subpixels having a second color component. As illustrated in FIG. 5B, the second color component in column 532-2 can be green (e.g., “G”). Adjacent subpixels of the second color component can alternately emit light to the second side of the display and to the first side 504 of the display 502. For example, a green subpixel in column 532-2 and row 534-1 can emit light to the second side of the display, a green subpixel in column 532-2 and row 534-2 can emit light to the first side 504 of the display 502, etc.

The third column 532-N can include subpixels having a third color component. As illustrated in FIG. 5B, the third color component in column 532-N can be blue (e.g., “B”). Adjacent subpixels of the second color component can alternately emit light to the first side 504 of the display and to the second side of the display 502. For example, a blue subpixel in column 532-N and row 534-1 can emit light to the first side 504 of the display 502, a blue subpixel in column 532-N and row 534-2 can emit light to the second side of the display 502, etc.

In other words, the second portion 510 of pixels can include an arrangement whereby different rows of pixels can alternately emit light to the first side 504 and second side of the display 502. The second portion 510 of pixels can be arranged in what appears to a user when viewed by the user to be a delta pixel arrangement (e.g., as is further described in connection with FIGS. 6A and 6B). Alternately emitting light to the first side 504 and the second side of the display 502 can prevent a visual artifact from being viewable by a user viewing the combined first portion 508 of pixels and second portion 510 of pixels when viewing the display 502 from the first side 504, while also allowing the second side (e.g., second side 106) of the display 502 to display information to a user. Further, utilizing the same pixel density in the second portion 510 of pixels as the first portion 508 of pixels can allow for easy manufacturing, more efficient power consumption, etc.

FIG. 6A illustrates an example of a display having a first subset of a second portion of pixels in a delta arrangement consistent with the disclosure. As illustrated in FIG. 6A, the first subset of the second portion of pixels can be in an actual delta arrangement 636 and an as-viewed delta arrangement 638.

As illustrated in FIG. 6A, the first subset (e.g., first subset 112-1, 212-1, 312-1, 412-1, 512-1, previously described in connection with FIGS. 1-5, respectively) can be pixels that emit light to the first side (e.g., first side 104, 204, 304, 404, 504, previously described in connection with FIGS. 1-5, respectively) of the display (e.g., display 102, 202, 302, 402, 502, previously described in connection with FIGS. 1-5, respectively). As previously described in connection with FIGS. 3, 4, 5A, and 5B, the first subset of pixels can be arranged in a delta arrangement. As used herein, the term “delta arrangement” refers to a triangular placement of pixels. For example, the delta arrangement 636 of the first subset of pixels can have the color components of the first subset of pixels be arranged in a triangular manner.

As previously described in connection with FIGS. 3, 4, 5A, and 5B, the first subset of pixels can be arranged such that different pixels in a particular row and/or column can alternately emit light to the first side and second side of the display. Accordingly, the actual delta arrangement 636 can include color components emitting light to the first side of the display but having a gap between then, as the color components of the pixel located in the gap emits light to the second side of the display.

However, a user viewing the first side of the display can view the pixel arrangement as the as-viewed delta arrangement 638. For example, when a user views the first side of the display, the human brain can compensate for the gap between the color components of the pixels emitting light to the first side of the display, and accordingly, can result in the user viewing the first side of the display as the as-viewed delta arrangement 638.

FIG. 6B illustrates an example of a display having a second subset of a second portion of pixels in a delta arrangement consistent with the disclosure. As illustrated in FIG. 6B, the second subset of the second portion of pixels can be in an actual delta arrangement 640 and an as-viewed delta arrangement 642.

As illustrated in FIG. 6B, the second subset (e.g., second subset 112-2, 212-2, 312-2, 412-2, 512-2, previously described in connection with FIGS. 1-5, respectively) can be pixels that emit light to the second side (e.g., second side 106, previously described in connection with FIG. 1) of the display (e.g., display 102, 202, 302, 402, 502, previously described in connection with FIGS. 1-5, respectively). As previously described in connection with FIGS. 3, 4, 5A, and 5B, the second subset of pixels can be arranged in a delta arrangement. For example, the delta arrangement 640 of the second subset of pixels can have the color components of the first subset of pixels be arranged in a triangular manner.

As previously described in connection with FIGS. 3, 4, 5A, and 5B, the second subset of pixels can be arranged such that different pixels in a particular row and/or column can alternately emit light to the first side and second side of the display. Accordingly, the actual delta arrangement 640 can include color components emitting light to the second side of the display but having a gap between then, as the color components of the pixel located in the gap emits light to the first side of the display.

However, a user viewing the second side of the display can view the pixel arrangement as the as-viewed delta arrangement 642. For example, when a user views the second side of the display, the human brain can compensate for the gap between the color components of the pixels emitting light to the second side of the display, and accordingly, can result in the user viewing the second side of the display as the as-viewed delta arrangement 642.

Displays having pixels, according to the disclosure, can allow for a single display that provides display of information to two sides of a display (e.g., a front side and a back side). The arrangement of pixels in the two sides of the display can allow for the single display to display information to the first side of the display, as well as for a portion of the display area of the display to display information to the first side and to the second side of the display, which can allow for the thickness of the display, the cost, and/or the power consumption of the display to be lower as compared with a device with two displays. The arrangement of pixels can prevent a visual artifact from being viewable by a user viewing the first side of the display while also allowing the second side of the display 302 to display information to a user.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” can refer to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 202 in FIG. 2. Elements shown in the various figures herein can be added, exchanged, and/or eliminated to provide additional examples of the disclosure. In addition, the proportion and the relative scale of the elements provided in the figures are intended to illustrate the examples of the disclosure and should not be taken in a limiting sense. As used herein, the designators “M” and “N”, particularly with respect to reference numerals in the drawings, indicate that a plurality of the particular feature so designated can be included with examples of the disclosure. The designators can represent the same or different numbers of the particular features.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples and data provide a description of the method and applications and use of the system and method of the disclosure. Since many examples can be made without departing from the spirit and scope of the system and method of the disclosure, this specification merely sets forth some of the many possible example configurations and implementations.

What is claimed is:

1. A display, comprising:
a first side, wherein the first side comprises:
a first portion of pixels that emit light to the first side of the display; and
a second portion of pixels, wherein a first subset of the second portion of pixels emit light to the first side of the display; and
a second side comprising a second subset of the second portion of pixels that emit light to the second side of the display, wherein a pixel density of the second portion of pixels is double a pixel density of the first portion of pixels.

2. The display of claim 1, wherein the second portion includes a plurality of columns and a plurality of rows, wherein each column includes subpixels having a color component.

3. The display of claim 2, wherein a first column of the plurality of columns includes subpixels having a first color component, wherein adjacent subpixels of the first color component are to altemately emit light to the first side of the display and to the second side of the display.

4. The display of claim 2, wherein a second column of the plurality of columns includes subpixels having a second color component, wherein adjacent subpixels of the second color component are to alternately emit light to the first side of the display and to the second side of the display.

5. The display of claim 2, wherein a third column of the plurality of columns includes subpixels having a third color component, wherein adjacent subpixels of the third color component are to altemately emit light to the first side of the display and to the second side of the display.

6. The display of claim 2, wherein each row of the plurality of rows includes:
a first subpixel having a first color component;
a second subpixel having a second color component; and
a third subpixel having a third color component;
wherein the first, second, and third subpixels of each row of the plurality of rows are to alternately emit light to the first side of the display and to the second side of the display.

7. The display of claim 1, wherein the first portion of pixels and the second portion of pixels include red, green, and blue (RGB) pixels.

8. A display, comprising:
a first side, wherein the first side comprises:
a first portion of pixels that emit light to the first side of the display; and
a second portion of pixels, wherein a first subset of the second portion of pixels emit light to the first side of the display; and
a second side comprising a second subset of the second portion of pixels that emit light to the second side of the display, wherein:
the first subset of pixels and the second subset of pixels are arranged in a delta arrangement;
each row of the second portion of pixels includes a plurality of adjacent subpixel pairs having same color components; and
a pixel density of the second portion of pixels is a same pixel density as the first portion of pixels.

9. The display of claim 8, wherein a first subpixel pair of the plurality of adjacent subpixel pairs includes:
a first subpixel of the first subpixel pair having a first color component to emit light to the first side of the display; and
a second subpixel of the first subpixel pair having the first color component to emit light to the second side of the display.

10. The display of claim 9, wherein a second subpixel pair of the plurality of adjacent subpixel pairs is located adjacent to the first subpixel pair and includes:
a first subpixel of the second subpixel pair having a second color component to emit light to the first side of the display; and
a second subpixel of the second subpixel pair having the second color component to emit light to the second side of the display.

11. The display of claim 10, wherein a third subpixel pair of the plurality of adjacent subpixel pairs is located adjacent to the second subpixel pair and includes:
a first subpixel of the third subpixel pair having a third color component to emit light to the first side of the display; and
a second subpixel of the third subpixel pair having the third color component to emit light to the second side of the display.

12. A display, comprising:
a first side, wherein the first side comprises:
a first portion of pixels that emit light to the first side of the display; and
a second portion of pixels, wherein a first subset of the second portion of pixels emit light to the first side of the display; and
a second side comprising a second subset of the second portion of pixels that emit light to the second side of the display, wherein:
the first subset of pixels and the second subset of pixels are arranged in a delta arrangement;
the second portion includes a plurality of columns and a plurality of rows, wherein each column of the plurality of columns includes subpixels having a color component and each subpixel along each row of the plurality of rows are to alternately emit light to the first side of the display and to the second side of the display; and
a pixel density of the second portion of pixels is a same pixel density as the first portion of pixels.

13. The display of claim 12, wherein a first column of the plurality of columns includes subpixels having a first color component, wherein adjacent subpixels of the first color component are to altemately emit light to the first side of the display and to the second side of the display.

14. The display of claim 12, wherein a second column of the plurality of columns includes subpixels having a second color component, wherein adjacent subpixels of the second color component are to alternately emit light to the first side of the display and to the second side of the display.

15. The display of claim 12, wherein a third column of the plurality of columns includes subpixels having a third color component, wherein adjacent subpixels of the third color component are to alternately emit light to the first side of the display and to the second side of the display.
